(19) United States
(12) Patent Application Publication
(10) Pub. No.: US 2025/0059990 A1
(43) Pub. Date: Feb. 20, 2025

(54) VORTEX SUPPRESSION DEVICE

(71) Applicant: HALDATEC PTY LTD, Mitcham (AU)

(72) Inventors: Cameron Seymour, Mitcham (AU); Nishal Matara, Mitcham (AU); Adam Dobbs, Mitcham (AU)

(21) Appl. No.: 18/937,284

(22) Filed: Nov. 5, 2024

Related U.S. Application Data
(63) Continuation of application No. 17/770,230, filed on Apr. 19, 2022, now Pat. No. 12,173,735.

(51) Int. Cl. F15D 1/00; E21B 49/08; F15D 1/12; F15D 1/14; G01N 1/20; G01N 17/04

(52) U.S. Cl. CPC F15D 1/0055; E21B 49/081; F15D 1/004; F15D 1/12; F15D 1/14; G01N 1/2035; G01N 17/043; G01N 2001/205

(57) ABSTRACT

A vortex suppressing sample probe for a fluid flowing along a pathway. The sample probe includes an elongate body with an outer surface having an elongate leading section and an elongate trailing section along the length of the elongate body, in relation to a direction of fluid flow when the device is located in the pathway. The elongate body can have at least one channel or groove which extends from the elongate leading section to the elongate trailing section of the elongate body. The channel or groove can be configured so that in use, when the device is in the pathway, the channel or groove allows fluid flow towards the trailing section that disrupts the formation of vortices. The groove can be a circumferential groove that follows a sinusoidal path around the outer surface of the elongate body.

### CROSS-REFERENCE TO RELATED APPLICATION

This application claims the benefit of priority of and is a continuation application under 35 U.S.C. § 120 based upon co-pending U.S. patent application Ser. No. 17/770,230 with a § 371 filing date of Apr. 19, 2022, which is a national stage entry of international patent application PCT/AU2020/051139 filed on Oct. 23, 2019. The entire disclosure of the prior applications are incorporated herein by reference.

### BACKGROUND

### Technical Field

In some aspects, the present technology relates to a vortex suppression device.

In some other aspects, the present technology relates to an instrument for inserting into a pipeline including a vortex suppression device.

In still some other aspects, the present technology relates to a vortex suppressing sample probe including an elongated body featuring grooves for vortex suppression and for use in connection with a pipeline.

### Background Description

In certain industries, such as the oil and gas industry, it is a requirement to periodically insert instruments inside a flowing stream, such as in a flowing process pipeline, to perform a variety of different tasks. Some of these tasks may include: sampling; injection; measurement; and corrosion monitoring.

An instrument for inserting into pipelines may include: a sample probe; a pipeline injector; a corrosion coupon, or any other sensors for determining the properties of the fluid.

Whilst the instruments involved in each of these tasks have a specific purpose, the overall intention is to undertake product quality control and to control/monitor pipeline integrity. The results of the analysis provide the operators of the pipeline with the necessary information to meet product specifications.

To perform any of the aforementioned tasks accurately, it is critical to insert an instrument inside a process pipeline during the production process. However, it is undesirable for the inserted instrument to interfere with the production process, such as fluid flow in the pipelines.

Inserting an instrument inside a process pipeline during a production process involves inserting the instrument inside the pipeline while the product is flowing in the pipeline.

Instruments for inserting into pipelines are typically cylindrical shaped. These instruments are generally inserted in a fixed position such that the flow of fluid travels transverse to a longitudinal axis of the instrument.

When a cylinder is introduced into a flow of fluid travelling transverse to a longitudinal axis of the cylinder, the flow decelerates as it impacts an outer surface of the cylinder. The elongate section of the outer surface of the cylinder at which flow first impacts the outer surface of the cylinder is also known as the “leading section” (or the “leading edge”) of the cylinder. The flow separates at the leading section and travels in opposite directions around the cylinder. As the flow travels around the cylinder it accelerates until it reaches a maximum velocity area. Beyond this point, the flow decelerates as it travels around the cylinder to a second low-velocity area where the flow rejoins and/or leaves the outer surface of the cylinder. The elongate section on the cylinder at which flow rejoins and/or leaves the outer surface of the cylinder is also known as the “trailing section” (or the “trailing edge”) of the cylinder.

The change in fluid velocity around the cylinder effects the pressure gradient around the cylinder according to Bernoulli's principle. The pressure gradient around the cylinder is determined by the flow regime in which the hydraulic system is operating in. Under certain flow regimes, the static pressure around the cylinder may be high enough to produce an adverse pressure gradient, i.e. one that acts against the direction of flow. This adverse pressure gradient causes recirculation of flow which results in separation of boundary layer flow from the cylinder. The flow that is separated can form vortices that shed asymmetrically (i.e. alternative shedding of vortices) in the wake of the cylinder.

The Reynolds number (Re) is a dimensionless parameter which can be used to categorize the flow regime in which a fluid flow is operating in. The Reynolds number can be considered a ratio of viscous forces to inertial forces. For low Reynolds numbers (Re<10) the flow conditions around the cylinder can be considered laminar, meaning the viscous forces are dominant and a boundary layer of low velocity fluid surrounds the cylinder. For Reynolds numbers of Re=˜10, inertial forces begin to dominate and the boundary layer surrounding the cylinder begins to separate and form vortices in the wake of the cylinder. With increases in Reynolds number (Re>˜90) the flow pattern around the body becomes asymmetric and the low-pressure zone moves across the surface of the cylinder resulting in alternate shedding of vortices, also known as a Kármán vortex street. The shedding of vortices continues until fully turbulent flow conditions are reached at around Re˜10⁵.

The alternate shedding of vortices produces an oscillatory force also known as vortex induced vibration (VIV). The magnitude and frequency of the VIV can result in damage to the inserted instrument which can also affect downstream equipment, and/or the pipeline itself. This is especially true for frequencies of vibration which match the resonant frequency of the inserted instrument.

The present technology seeks to address the issues associated with vortex induced vibration, or to at least provide the consumer with a useful alternative.

### SUMMARY

In view of the foregoing disadvantages inherent in the known types of vortex reducing systems at least some embodiments of the present technology provides a novel dismountable vortex suppression device, and overcomes one or more of the mentioned disadvantages and drawbacks of the prior art. As such, the general purpose of at least some embodiments of the present technology, which will be described subsequently in greater detail, is to provide a new and novel vortex suppression device which has all the advantages of the prior art mentioned herein and many novel features that result in a vortex suppression device which is not anticipated, rendered obvious, suggested, or even implied by the prior art, either alone or in any combination thereof.

According to one aspect, the present technology can include a vortex suppressing sample probe for a fluid flowing in a pipeline. The sample probe can include an elongate body with an outer surface having a leading section and a trailing section along a length of the elongate body, in relation to a direction of fluid flow when the sample probe is located in the pipeline. The elongate body can have one or more grooves defined in the outer surface and that extend from the leading section to the trailing section of the elongate body. The grooves can be configured so that in use, when the sample probe is in the pipeline, the grooves allow fluid flow towards the trailing section that disrupts the formation of vortices.

According to another aspect, the present technology can include a vortex suppressing sample probe for a fluid flowing in a pipeline. The sample probe can include an elongate body, and a flow regulating arrangement. The elongate body can have a first end, a second end, an internal passage extending between the first end and the second end for collecting fluid samples, and an outer surface including a leading section and a trailing section along a length of the elongate body, in relation to a direction of fluid flow when the sample probe is located in the pipeline. The elongate body can have one or more grooves defined in the outer surface and that extend from the leading section to the trailing section of the elongate body. The grooves can be configured so that in use, when the sample probe is in the pipeline, the grooves allow fluid flow towards the trailing section that disrupts the formation of vortices. The flow regulating arrangement can be located at the first end, and can include a valve in fluid communication with the internal passage for regulating the flow of fluid into or out of the internal passage.

In some embodiments, the grooves can follow a path around the elongate body selected from the group consisting of any one or any combination of a sinusoidal path, a circumferential path, and helical path.

In some embodiments, the grooves can be circumferential grooves that follow a sinusoidal path around the outer surface of the elongate body. The circumferential grooves can extend transversely to a longitudinal axis of the elongate body from the elongate leading section to the elongate trailing section.

In some embodiments, the elongate body can have a first end, a second end and an internal passage extending between the first end and the second end for collecting fluid samples.

In some embodiments, the elongate body can include a threaded connection located at the second end for connecting the sample probe to an auxiliary piece of equipment.

In some embodiments, the sample probe can further include a flow regulating arrangement located at the first end for regulating the flow of fluid into or out of the internal passage.

In some embodiments, the flow regulating arrangement can include a valve in fluid communication with the internal passage.

In some embodiments, the valve can include a poppet valve body, and a spring configured to bias the poppet valve body to rest on an annular valve seat.

In some embodiments, the spring can be located in an internal flow regulating passage defined in the flow regulating arrangement.

In some embodiments, the flow regulating arrangement can include a filter in fluid communication with the internal flow regulating passage.

In some embodiments, the elongate body can be configured to be inserted into the pipeline

In some embodiments, the elongate body can include any one of or combination selected from the group consisting of an injection nozzle for dispersion of liquids, a measurement device for determining fluid properties, and a corrosion coupon for monitoring corrosion of the pipeline.

In yet another aspect there is disclosed a vortex suppression device for fluid flowing along a pathway, including: an elongate body with an outer surface having an elongate leading section and an elongate trailing section along the length of the elongate body, in relation to a direction of fluid flow when the device is located in the pathway, the elongate body having at least one channel which extends from the leading section to the trailing section of the elongate body, the channel being configured so that in use, when the device is in the pathway, the channel allows fluid flow towards the trailing section that disrupts the formation of vortices.

In still another aspect there is disclosed a vortex suppression device for fluid flowing along a pathway, including: an elongate body with an outer surface having an elongate leading section and an elongate trailing section along the length of the elongate body, in relation to a direction of fluid flow when the device is located in the pathway, the elongate body having at least one channel which extends transversely to a longitudinal axis of the elongate body from the leading section to the trailing section of the elongate body, the channel being configured so that in use, when the device is in the pathway, the channel allows fluid flow towards the trailing section that disrupts the formation of vortices.

The channel essentially directs high velocity fluid flow from upstream of the elongate body to downstream of the elongate body in order to reduce the static pressure downstream of the elongate body. Reducing the static pressure assists in preventing the formation of an adverse pressure gradient. This reduces the amount of boundary layer flow separation which, in turn, disrupts the formation of vortices.

In some embodiments, the elongate body has a circular or oval cross-section.

In some embodiments, the elongate body may also have a polygonal cross-section.

In some embodiments, the outer surface is dimpled or undulated. The dimples or undulations act to increase turbulent flow in the boundary layer, which assists in preventing boundary layer flow separation.

In some embodiments, the at least one channel comprises a groove in the outer surface of the elongate body.

In some embodiments, the groove follows a sinusoidal path around the elongate body.

In some embodiments, the groove follows a circumferential or helical path around the elongate body.

In some embodiments, the elongate body comprises a plurality of grooves, each groove following a sinusoidal path, circumferential path, or helical path. The grooves may share the same path shape of follow different paths. For example, the elongate body may have three grooves, two of the grooves follow a circumferential path and one of the grooves follows a sinusoidal path.

In some embodiments, the at least one channel extends through the elongate body.

In these embodiments, the at least one channel may have a rectangular cross-section having a width and a height, the width extending parallel to the longitudinal axis of the elongate body. The height of each channel may be greater than 1 mm. Suitably, the height of each channel may be between 2 mm and 4 mm. More suitably, the height of each channel may be 3 mm.

In some embodiments, the channel is offset from a centerline of the cross-section of the elongate body. The channel may be offset by a distance greater than 4.5 mm. Suitably, channel may be offset by a distance between 4.5 mm and 12 mm. More suitably, the channel may be offset by a distance of 6.5 mm or by 9.5 mm.

In some embodiments, the vortex suppression device has at least one opening in the outer surface of the elongate body. At least one of the channels may intersect with the at least one opening.

In some embodiments, the vortex suppression device has at least two diametrically opposed openings in the outer surface of the elongate body. The elongate body may include at least two channels, two of the channels each intersecting with openings in the outer surface of the elongate body.

In some embodiments, the elongate body includes at least four channels, two of the channels each intersecting with openings in the outer surface of the elongate body.

In some embodiments, each opening has a rectangular cross-section having a width and a height, the width extending parallel to the longitudinal axis of the elongate body. The height of each opening may be greater than 1 mm. Suitably, the height of each opening may be between 2 mm and 4 mm. More suitably, the height of each opening may be 3 mm.

In some embodiments, the elongate body is a sample probe having a first end and a second end and an internal passage extending between the first end and the second end for collecting fluid samples.

In some embodiments, the sample probe includes a threaded connection located at the second end for connecting the sample probe to an auxiliary piece of equipment.

In some embodiments, the sample probe includes a flow regulating arrangement located at the first end for regulating the flow of fluid into or out of the internal passage.

In some embodiments, the flow regulating arrangement is a valve and/or a filter.

In some embodiments of the vortex suppression device, the elongate body may include any one, or combination, of the following: a) a sample probe; b) an injection nozzle for the dispersion of liquids; c) a measurement device for determining fluid properties; or d) a corrosion coupon for monitoring pipeline corrosion.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is therefore an object of the present technology to provide a new and novel vortex suppression device that has all of the advantages of the prior art vortex reducing systems and none of the disadvantages.

It is another object of the present technology to provide a new and novel vortex suppression device that may be easily and efficiently manufactured and marketed.

An even further object of the present technology is to provide a new and novel vortex suppression device that has a low cost of manufacture with regard to both materials and labor, and which accordingly is then susceptible of low prices of sale to the consuming public, thereby making such vortex suppression device economically available to the buying public.

Still another object of the present technology is to provide a new vortex suppression device that provides in the apparatuses and methods of the prior art some of the advantages thereof, while simultaneously overcoming some of the disadvantages normally associated therewith.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the claimed present technology is not limited to meeting most or all of the objects identified and that some embodiments of the present technology may meet only one such object or none at all.

### BRIEF DESCRIPTION OF THE DRAWINGS

The present technology will be better understood and objects other than those set forth above will become apparent when consideration is given to the following detailed description thereof. Such description makes reference to the annexed drawings wherein:

FIG. 1 is a front view of a vortex suppression device according to a first embodiment of the present technology;

FIG. 2 is a cross-sectional view 2-2 of the vortex suppression device of FIG. 1;

FIG. 3 is an end view of the vortex suppression device of FIG. 1;

FIG. 4 is a velocity plot results of a computational flow simulation for flow around a cylinder;

FIG. 5 is a velocity plot results of a computational flow simulation for flow around the vortex suppression device of FIG. 1;

FIG. 6 is a perspective view of a vortex suppression device according to a second embodiment of the present technology;

FIG. 7 is a cross-sectional view, along plane on the longitudinal axis, of the vortex suppression device shown in FIG. 6;

FIG. 8 is a perspective view of the vortex suppression device according to a third embodiment of the present technology;

FIGS. 9A to 9D are plane views of the vortex suppression device of FIG. 8 taken at 90 degree increments around the longitudinal axis of device, wherein:

FIG. 9A is a first plane view (at 0 degrees);

FIG. 9B is a second plane view (at 90 degrees);

FIG. 9C is a third plane view (at 180 degrees);

FIG. 9D is a fourth plane view (at 270 degrees); and

FIG. 10 is a cross-sectional view along the line 10-10 in FIG. 9D.

The same reference numerals refer to the same parts throughout the various figures.

### DETAILED DESCRIPTION OF THE EMBODIMENTS

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

The Figures show three embodiments of the vortex suppression device of the present technology. It is noted that these are not the only embodiments.

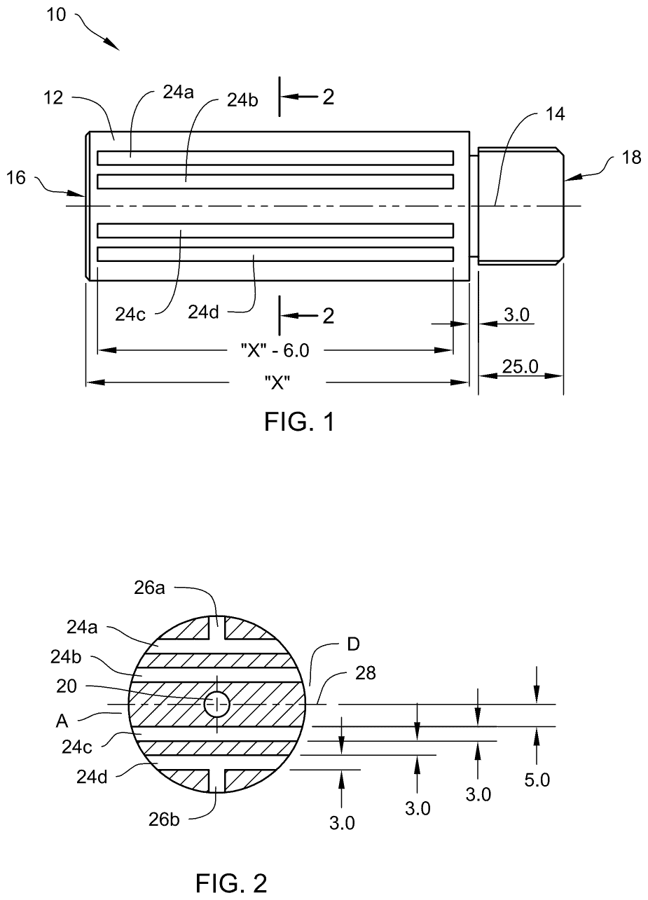

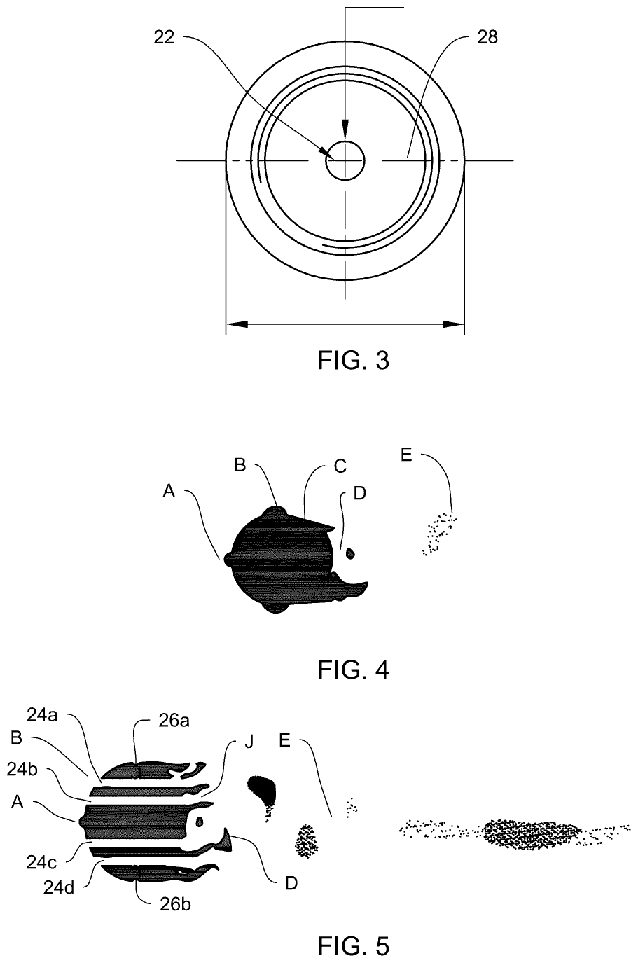

Referring firstly to FIGS. 1 to 3, a first embodiment of the vortex suppression device is shown in the form of a sample probe 10 having a cylindrical shaped elongate body 12 with an outer surface defining a longitudinal axis 14. The elongate body 12 has a first end 16, a second end 18 and an internal sampling passage 20, extending between the first and second ends 16, 18, for collecting fluid samples (as shown in FIG. 2). The second end 18 has a male threaded connection for connecting the sample probe to an auxiliary piece of equipment. The first end 16 has an aperture 22 (as shown in FIG. 3) for receiving flow of fluid into the sampling passage 20.

As can be seen from FIG. 2, the elongate body 12 includes channels 24a, 24b, 24c, 24d which extend transversely to the longitudinal axis 14 of the elongate body 12, through the elongate body 12.

When the sample probe 10 is positioned in a flow of fluid along a pathway (for example, see FIG. 5: fluid is flowing past the sample probe 10 in the direction of A to E), the outer surface defines an elongate leading section along the length of the sample probe 10 (for example, see FIG. 5: section of sample probe 10 local to area A) and an elongate trailing section along the length of the sample probe 10 (for example, see FIG. 5: section of the sample probe 10 local to Area D) in relation to a direction of fluid flow.

In use, the sample probe 10 is introduced to a fluid flow and oriented such that the longitudinal axis 14 is perpendicular to the direction of fluid flow and the channels 24a, 24b, 24c, 24d are aligned with the direction of fluid flow. In such an orientation, fluid flow enters these channels 24a, 24b, 24c, 24d, at the elongate leading section and flows through the elongate body 12 and exists the channels 24a, 24b, 24c, 24d at the elongate trailing section of the elongate body 12. High velocity fluid from the leading section of the elongate body 12 exists the channels at the trailing section of the elongate body 12 forming what is known as ‘passive jets’. These ‘passive jets’ reduce the static pressure downstream of the elongate body which assists in preventing the formation of an adverse pressure gradient. This reduces the amount of boundary layer flow separation which, in turn, disrupts the formation of vortices.

FIG. 2 also shows two diametrically opposed openings 26a, 26b in the outer surface of the elongate body 12. The channels 24a and 24d intersect, perpendicularly, with two diametrically opposed openings 26a, 26b, respectively, to form ‘passive jets’ at multiple angles around the elongate body 12.

The applicant has found that producing ‘passive jets’ at multiple angles around the elongate body 12 provides a more even pressure gradient around the elongate body 12. The channels 24a, 24b, 24c, 24d and openings 26a, 26b direct the high velocity fluid from the leading section of the elongate body 12 to the low-pressure area behind the trailing section of the elongate body 12 in order to restrict the transverse fluid motion around the elongate body 12 using the kinetic energy available in the flow. This not only reduces the boundary layer flow separation from the trailing section of the elongate body 12, but also reduces boundary layer flow separation from the elongate body 12 at other positions located between the leading section and the trailing section of the elongate body 12. The applicant has found that having more than one channel 24 reduces the severity of alternate shedding of vortices by increasing the kinetic energy available for vortex suppression at the trailing section of the elongate body 12.

FIG. 2 shows that the elongate body has a centreline 28 and that each of the channels 24a, 24b, 24c, 24d are offset from the centreline 28. A pair of channels 24b, 24c are offset by a distance typically greater than 4.5 mm. In the described embodiment the pair of channels 24b, 24c are offset by a distance of 6.5 mm and another pair of channels 24a, 24d are offset by a distance of 9.5 mm.

FIG. 1 shows that the channels 24a, 24b, 24c, 24d have a rectangular cross-section having a width and a height; the width extending parallel to the longitudinal axis 14 of the elongate body 12. The width of each of the channels 24a, 24b, 24c, 24d extends substantially the entire length of the elongate body 12 and the height of each the channels 24 is typically greater than 1 mm. In the described embodiment the height is 3 mm. It is advantageous for each of the channels 24a, 24b, 24c, 24d to have a constant cross-sectional size throughout its length in order to allow transfer of kinetic energy with minimal energy loss. In other words, it is typically undesirable to have any flow restrictions in the channels 24a, 24b, 24c, 24d.

Each of the openings 26a, 26b has a rectangular cross-section having a width and a height; the width extending parallel to the longitudinal axis 14 of the elongate body 12. The width of each of the openings 26a, 26b extends substantially the entire length of the elongate body 12 and the height of each of the openings 26a, 26b is typically greater than 1 mm. In the described embodiment the height is 3 mm. It is advantageous for each of the openings 26a, 26b to have a constant cross-section throughout its length in order to allow transfer of kinetic energy with minimal energy loss. In other words, it is typically undesirable to have any flow restrictions in the openings 26a, 26b.

FIG. 3 shows an end view of the first end 16 of the sample probe shown in FIG. 1. As can be seen from FIG. 3, the sample probe includes an aperture 22 which allows fluid flow to enter the sampling passage 20 and flow in a direction along the longitudinal axis 14 of the elongate body 12. The sampling passage 20 is used to obtain a sample from the fluid flow which can then be analysed to determine the properties of the fluid.

FIGS. 4 and 5 are comparative velocity plot results of a computational flow simulation of flow around a cylinder C (as shown in FIG. 4) with and the vortex suppression device 10 of the present technology (as shown in FIG. 5). Both simulations used the same fluid flow conditions, i.e. the same Reynolds number.

FIG. 4 shows a cylinder C in a flow of fluid traveling from A-E. The flow decelerates as it impacts the leading section of the cylinder C and forms a low-velocity area A. The flow separates at the leading section and travels in opposite directions around the cylinder C. As the flow travels around the cylinder it accelerates until it reaches a maximum velocity area B. Beyond this point, the flow decelerates as it travels around the cylinder C to a second low-velocity area D. The change in fluid velocity around the cylinder effects the pressure gradient around the cylinder according to Bernoulli's principle. At areas of low-velocity, such as at area D, the static pressure is high enough to produce an adverse pressure gradient, i.e. one that acts against the direction of flow. This adverse pressure gradient causes recirculation of flow and ultimately separation of boundary layer flow from the cylinder C. The flow that is separated in area D produces alternate shedding of vortices E in the wake of the cylinder C, also known as a Kármán vortex street.

FIG. 5 shows the vortex suppression device 10 in a flow of fluid traveling from A-E. The flow decelerates as it impacts the leading section of the vortex suppression device 10 and forms a low-velocity area A. The flow separates at the leading section and travels in opposite directions around the vortex suppression device 10. As the flow travels around the vortex suppression device 10 it accelerates until it reaches a maximum velocity area B proximal to the entrances of the channels 24a-24d. The flow from the maximum velocity area B is then conducted along the channels 24a-24d and openings 26a, 26b to the trailing section of the vortex suppression device 10 to exit the channels 24a-24d and openings 26a, 26b as ‘passive jets’ J. The ‘passive jets’ J reduce the static pressure downstream of the vortex suppression device 10. Reducing the static pressure assists in preventing the formation of an adverse pressure gradient. This reduces the amount of boundary layer flow separation which, in turn, disrupts the formation of vortices. Furthermore, the channels 24a-24d also reduce the severity of alternate shedding of vortices, i.e. a Kármán vortex street, by constraining the movement of the low-pressure zone to between the channels 24a-24d.

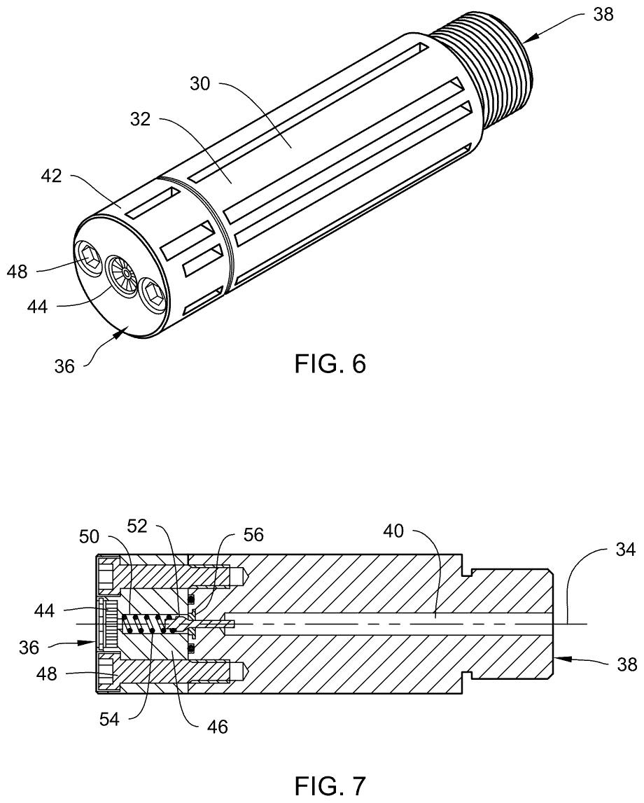

FIGS. 6 and 7 show a second embodiment of the vortex suppression device in the form of a different sample probe 30 having an elongate body 32 with, an outer surface defining a longitudinal axis 34, a first end 36, and a second end 38. Between the first and second ends 36, 38 is an internal sampling passage 40 for collecting fluid samples. The embodiment shown in FIGS. 6 and 7 operates in much the same way as the embodiment of FIG. 1. However, the first end 36 of the sample probe includes a flow regulating arrangement 42 for regulating the flow into/out of the sampling passage 40. The flow regulating arrangement 42 is a cylindrical component that is releasably attached to the first end 36 of the sample probe 30 by bolts 48. The flow regulating arrangement 42 also includes channels and openings as previously described in FIGS. 1 to 3.

As can be seen in FIG. 7, the flow regulating arrangement 42 comprises an internal passage 50 which aligns and fluidly communicates with the sampling passage 40. The internal passage 50 has an opening in which a filter 44, in the form of a perforated disc, is located. The filter 44 acts to prevent particles over a certain size from entering the internal passage 50. Inside the internal passage 50 is a valve arrangement 46 which comprises a poppet valve body 52 that is biased to rest on an annular valve seat 56 by a helical spring 54. The valve arrangement 46 regulates flow into/out of the sampling passage 40.

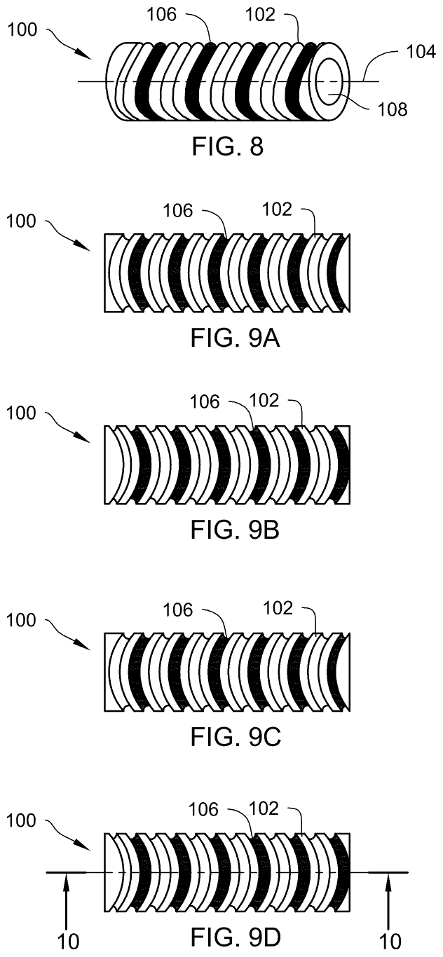

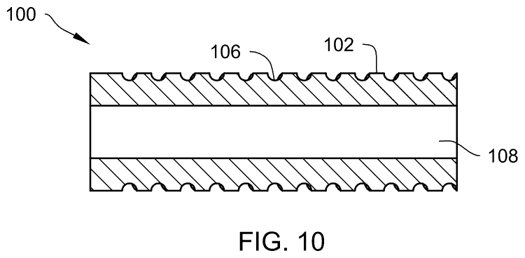

FIGS. 8 to 10 illustrate a third embodiment of the vortex suppression device in the form of a sample probe 100 having a cylindrical shaped elongate body 102 with an outer surface defining a longitudinal axis 104.

When the sample probe 100 is positioned in a fluid flow, the outer surface has an elongate leading section and an elongate trailing section in relation to a direction of fluid flow. The elongate body 102 has channels, in the form of circumferential grooves 106 that follow a sinusoidal path around the outer surface of the elongate body 102, which extend transversely to the longitudinal axis 104 of the elongate body 102 from the elongate leading section to the elongate trailing section of the elongate body 102. The grooves 106 are illustrated in alternating colours, blue and red. These colours are merely to distinguish one groove from the grooves that are adjacent to it. The grooves 106 reduce vortex induced vibration by conducting high velocity fluid flow from the leading section to the trailing section of the elongate body 102. The high velocity fluid at the trailing section reduces static pressure downstream of the elongate body 102. Reducing the static pressure assists in preventing the formation of an adverse pressure gradient. This reduces the amount of boundary layer flow separation, which in turn, disrupts the formation of vortices.

As can be appreciated, the sample probe 100 functions in the same manner as sample probes 10 and 30. However, unlike the sample probes 10 or 30, the sample probe 100 can be oriented at any angle, provided the fluid flow is travelling in a direction transversely to the longitudinal axis of the elongate body 102, without reducing its effectiveness at disrupting vortices. This is because the grooves 106 extend around the outer surface of the elongate body 102 rather than through the elongate body 102.

A further advantage of the sample probe 100, is that the circumferential grooves 106 transfer high velocity flow to the trailing section with greater efficiency than the channels/openings of sample probes 10 and 30. In other words, the high velocity flow is conducted to the tailing section with fewer and less severe directional changes. Severe directional changes should be avoided as they can result in energy losses. Because of this, the sample probe 100 can be made smaller than the sample probes 10 or 30, whilst providing the same vortex suppression capability. Reducing the size of the sample probe reduces materials and manufacturing costs.

In the embodiments previously discussed the elongate body 12, 32, 102 is shown to be cylindrical shaped. However, it is envisaged that elongate bodies of other shapes are within the scope of the present technology.

The sample probes 10, 30, 100 can be made from any suitable material, preferably a corrosion resistant material, such as stainless steel, titanium, aluminum, brass . . . etc.

Whilst a number of specific embodiments have been described, it should be appreciated that the device may be embodied in many other forms. The present technology has been described in the context of a sample probe, however, the present technology should not be considered limited to this use. This present technology is suitable for suppressing vortices produced as a result of an instrument being inserted into a flow of fluid. The present technology is therefore suitable for other applications, for example flow meters, injection quills, siphons, corrosion coupon holders and thermowells.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

Further patent applications may be filed in Australia or overseas on the basis of, or claiming priority from, the present application. It is to be understood that the following provisional claims are provided by use of example only and are not intended to limit the scope of what may be claimed in any such future applications. Features may be added to or omitted from the provisional claims at a later date so is to further define or re-define the present technology or technologies.

While embodiments of the vortex suppression device have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

### KEY

10: sample probe without regulation means
12: elongate body
14: longitudinal axis
16: first end
18: second end
20: sampling passage
22: aperture
24a-d: channel
26a, 26b: opening
28: centerline
30: sample probe with regulation means
32: elongate body
34: longitudinal axis
36: first end
38: second end
40: sampling passage
42: regulating arrangement
44: filter
46: valve arrangement
48: bolts
50: internal passage
52: valve body
54: spring
56: seat
100: vortex suppression device
102: elongate body
104: longitudinal axis
106: grooves
108: sampling passage

What is claimed as being new and desired to be protected by Letters Patent of the United States is as follows:

1. A vortex suppressing sample probe for a fluid flowing in a pipeline, the sample probe comprising:
an elongate body with an outer surface having a leading section and a trailing section along a length of the elongate body, in relation to a direction of fluid flow when the sample probe is located in the pipeline, the elongate body having one or more grooves defined in the outer surface and that extend from the leading section to the trailing section of the elongate body, the grooves being configured so that in use, when the sample probe is in the pipeline, the grooves allow fluid flow towards the trailing section that disrupts a formation of vortices.

2. The sample probe of claim 1, wherein the grooves follow a path around the elongate body selected from the group consisting of a sinusoidal path, a circumferential path, and helical path.

3. The sample probe of claim 1, wherein the grooves are circumferential grooves that follow a sinusoidal path around the outer surface of the elongate body, and wherein the circumferential grooves extend transversely to a longitudinal axis of the elongate body from the leading section to the trailing section.

4. The sample probe of claim 1, wherein the elongate body having a first end, a second end and an internal passage extending between the first end and the second end for collecting fluid samples.

5. The sample probe of claim 4, wherein the elongate body further comprising a threaded connection located at the second end for connecting the sample probe to an auxiliary piece of equipment.

6. The sample probe of claim 4, wherein the sample probe further comprising a flow regulating arrangement located at the first end for regulating the flow of fluid into or out of the internal passage.

7. The sample probe of claim 6, wherein the flow regulating arrangement includes a valve in fluid communication with the internal passage.

8. The sample probe of claim 7, wherein the valve includes a poppet valve body, and a spring configured to bias the poppet valve body to rest on an annular valve seat.

9. The sample probe of claim 8, wherein the spring is located in an internal flow regulating passage defined in the flow regulating arrangement.

10. The sample probe of claim 9, wherein the flow regulating arrangement includes a filter in fluid communication with the internal flow regulating passage.

11. The sample probe of claim 1, wherein the elongate body is configured to be inserted into the pipeline.

12. The sample probe of claim 1, wherein the elongate body includes any one of or combination selected from the group consisting of an injection nozzle for dispersion of liquids, a measurement device for determining fluid properties, and a corrosion coupon for monitoring corrosion of the pipeline.

13. A vortex suppressing sample probe for a fluid flowing in a pipeline, the sample probe comprising:
an elongate body having a first end, a second end, an internal passage extending between the first end and the second end for collecting fluid samples, and an outer surface including a leading section and a trailing section along a length of the elongate body, in relation to a direction of fluid flow when the sample probe is located in the pipeline, the elongate body having one or more grooves defined in the outer surface and that extend from the leading section to the trailing section of the elongate body, the grooves being configured so that in use, when the sample probe is in the pipeline, the grooves allow fluid flow towards the trailing section that disrupts a formation of vortices; and
a flow regulating arrangement located at the first end, the flow regulating arrangement includes a valve in fluid communication with the internal passage for regulating the flow of fluid into or out of the internal passage.

14. The sample probe of claim 13, wherein the grooves follow a path around the elongate body selected from the group consisting of any one or any combination of a sinusoidal path, a circumferential path, and helical path.

15. The sample probe of claim 13, wherein the grooves are circumferential grooves that follow a sinusoidal path around the outer surface of the elongate body, and wherein the circumferential grooves extend transversely to a longitudinal axis of the elongate body from the leading section to the trailing section.

16. The sample probe of claim 13, wherein the elongate body further comprising a threaded connection located at the second end for connecting the sample probe to an auxiliary piece of equipment.

17. The sample probe of claim 13, wherein the valve includes a poppet valve body, and a spring configured to bias the poppet valve body to rest on an annular valve seat.

18. The sample probe of claim 17, wherein the spring is located in an internal flow regulating passage defined in the flow regulating arrangement.

19. The sample probe of claim 18, wherein the flow regulating arrangement includes a filter in fluid communication with the internal flow regulating passage.
